(19) United States
(12) Patent Application Publication
(10) Pub. No.: US 2018/0186283 A1
(43) Pub. Date: Jul. 5, 2018

(54) SYSTEMS AND METHODS FOR AUTOMATICALLY DEPLOYING ROAD HAZARD INDICATORS

(71) Applicant: Faraday&Future Inc., Gardena, CA (US)

(72) Inventors: Evan Roger Fischer, Torrance, CA (US); Hong S. Bae, Torrance, CA (US); Aziz Umit Batur, Torrance, CA (US); Kwang Keun J. Shin, Torrance, CA (US)

(21) Appl. No.: 15/719,282

(22) Filed: Sep. 28, 2017

Related U.S. Application Data
(60) Provisional application No. 62/401,772, filed on Sep. 29, 2016.

(51) Int. Cl. B60Q 1/46; G07C 5/08; G07C 5/00; B60Q 7/00

(52) U.S. Cl. CPC B60Q 1/46; G07C 5/0808; G05D 1/02; G07C 5/008; B60Q 7/005; G07C 5/0816

(57) ABSTRACT

A system that performs a method is disclosed. The system detects one or more characteristics about a vehicle via a first set of one or more sensors and determines one or more characteristics about the vehicle's surroundings via a second set of one or more sensors. The system also detects a vehicle failure via the first set of one or more sensors. In response to detecting the vehicle failure via the first one or more sensors, the system selects one or more road hazard indicators using the one or more characteristics about the vehicle's surroundings. After selecting the one or more road hazard indicators using the one or more characteristics about the vehicle's surroundings, the system deploys the one or more road hazard indicators.

### CROSS-REFERENCE TO RELATED APPLICATIONS

This application claims the benefit of U.S. Patent Application No. 62/401,772, filed Sep. 29, 2016, the entirety of which is hereby incorporated by reference.

### FIELD OF THE DISCLOSURE

The various embodiments of the present invention relate generally to automatically deploying road hazard indicators.

### BACKGROUND OF THE DISCLOSURE

When a vehicle breaks down in a driving lane or off of the side of the road, a driver may want to place road hazard indicators (e.g., flares, reflective triangles, cones, or other road hazard signage) behind the vehicle to warn other vehicles. However, exiting the vehicle to place road hazard indicators may be too dangerous. Moreover, a driver may not be available to place the road hazard indicators if the vehicle is an autonomous vehicle. Therefore, a simple solution for automatically deploying road hazard indicators can be desirable.

### SUMMARY OF THE DISCLOSURE

Examples of the disclosure are directed to automatically deploying road hazard indicators when a vehicle failure occurs. Upon detecting the vehicle failure, the vehicle can automatically slow down and stop the vehicle on the side of the road, if possible. The vehicle can also select appropriate road hazard indicators and automatically deploy (e.g., drop, launch, illuminate, and/or project) those road hazard indicators behind the vehicle. Additionally, the vehicle can retract (e.g., collect the road hazard indicators) once the vehicle failure has been addressed. The vehicle can also deploy a ground-based robot and/or a drone to place and/or collect the road hazard indicators behind the vehicle. In this way, the vehicle can safely deploy road hazard indicators without requiring a driver, user, or passenger to exit the vehicle.

### BRIEF DESCRIPTION OF THE DRAWINGS

FIG. 1 illustrates an exemplary system block diagram of a vehicle control system according to examples of the disclosure.

FIG. 2A illustrates an exemplary vehicle automatically detecting a failure while driving along a road according to examples of the disclosure.

FIG. 2B illustrates an exemplary vehicle automatically deploying road hazard indicators according to examples of the disclosure.

FIG. 2C illustrates an exemplary vehicle automatically projecting images of road hazard indicators according to examples of the disclosure.

FIG. 3 illustrates an exemplary process for automatically deploying road hazard indicators according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to either autonomous driving, partially autonomous driving, and/or driver assistance systems.

Some vehicles, such as automobiles, can include various sensors for detecting vehicle failures. Some vehicles can also include various systems and sensors for determining the vehicle's location (including speed and/or orientation), for detecting one or more characteristics about the vehicle's surroundings, and for detecting one or more characteristics about the vehicle. Examples of the disclosure are directed to using such information for automatically deploying road hazard indicators. Upon detecting a vehicle failure, the vehicle can automatically slow down and stop the vehicle on the side of the road, if possible. The vehicle can also select appropriate road hazard indicators and automatically deploy (e.g., drop, launch, illuminate, and/or project) those road hazard indicators behind the vehicle. Additionally, the vehicle can retract (e.g., collect the road hazard indicators) once the vehicle failure has been addressed. The vehicle can also deploy a ground-based robot and/or a drone to place and/or collect the road hazard indicators behind the vehicle. In some examples, a user can invoke the deployment of the road hazard indicators for any reason. In this way, the vehicle can safely deploy road hazard indicators without requiring a driver, user, or passenger to exit the vehicle.

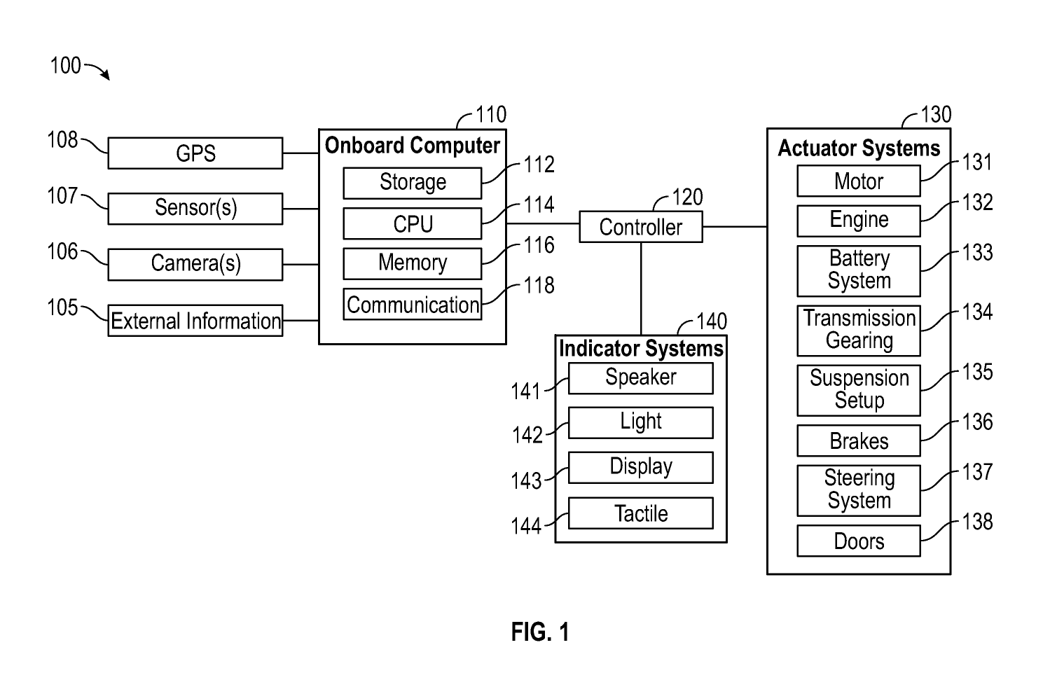

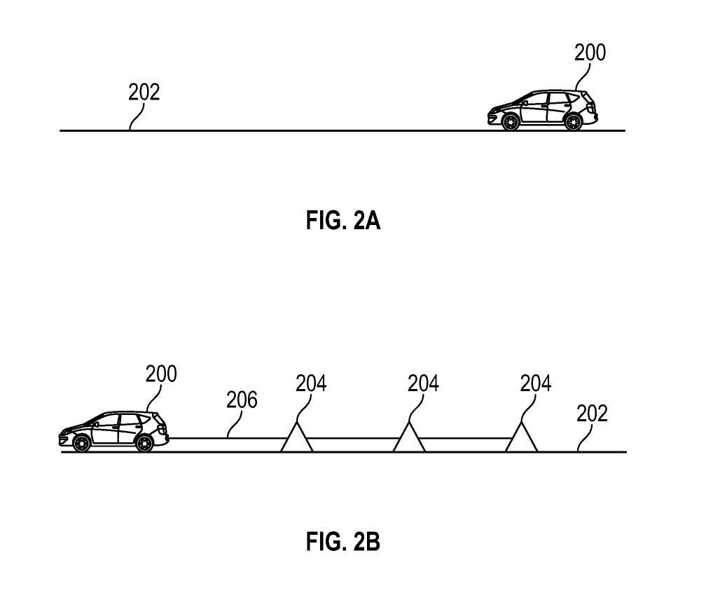

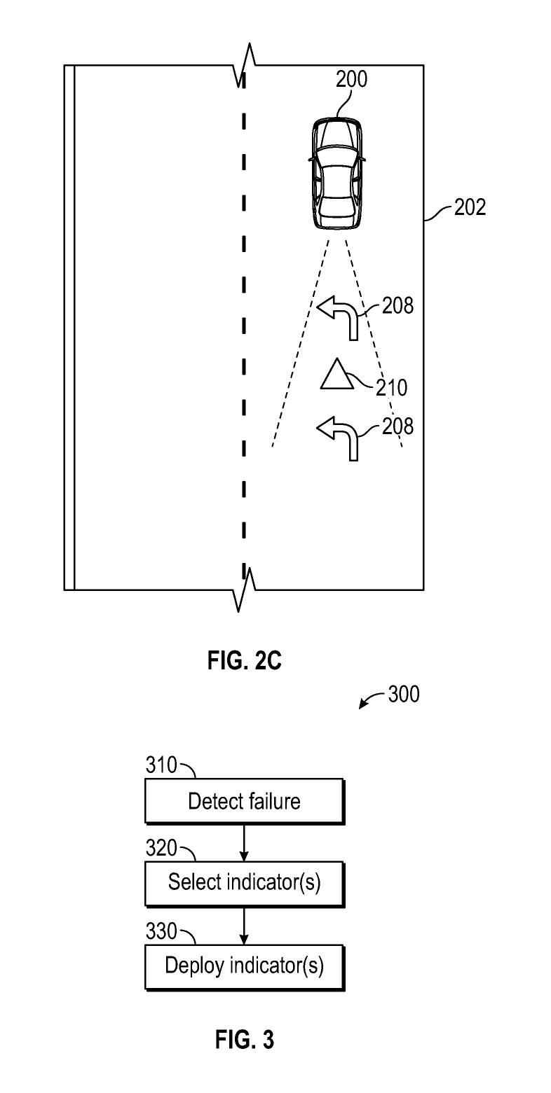

FIG. 1 illustrates an exemplary system block diagram of vehicle control system 100 according to examples of the disclosure. Vehicle control system 100 can perform any of the methods described with reference to FIGS. 2A-2C and 3. Vehicle control system 100 can be incorporated into a vehicle, such as a consumer automobile. Other examples of vehicles that may incorporate the vehicle control system 100 include, without limitation, airplanes, boats, or industrial automobiles. Vehicle control system 100 can include one or more cameras 106 for determining various characteristics of the vehicle's surroundings, as described below with reference to FIGS. 2A-2C and 3. Vehicle control system 100 can also include one or more other sensors 107 (e.g., radar, ultrasonic, laser, LIDAR, accelerometer, gyroscope, pressure, temperature, speed, air flow, or smoke) and a Global Positioning System (GPS) receiver 108 for detecting various characteristics about the vehicle and about the vehicle's surroundings. In some examples, sensor data can be fused together. This fusion can occur at one or more electronic control units (ECUs) (not shown). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance. Vehicle control system 100 can also receive (e.g., via an internet connection) external information such as weather and/or map information from other vehicles or from an internet source via an external information interface 105 (e.g., a cellular Internet interface or a Wi-Fi Internet interface). Vehicle control system 100 can include an on-board computer 110 that is coupled to cameras 106, sensors 107, GPS receiver 108, and external information interface 105, and that is capable of receiving the image data from the cameras and/or outputs from the sensors 107, the GPS receiver 108, and the external information interface 105. On-board computer 110 can include storage 112, memory 116, communications interface 118, and a processor 114. Processor 114 can perform any of the methods described with references to FIGS. 2A-2C and 3. Additionally, communications interface 118 can perform any of the communications described with reference to FIGS. 2A-2C and 3. Moreover, storage 112 and/or memory 116 can store data and instructions for performing any of the methods described with references to FIGS. 2A-2C and 3. Storage 112 and/or memory 116 can be any non-transitory computer-readable storage medium, such as a solid-state drive or a hard disk drive, among other possibilities. The vehicle control system 100 can also include a controller 120 capable of controlling one or more aspects of vehicle operation, such as performing autonomous or semi-autonomous driving maneuvers and/or adapting vehicle operations as described below with references to FIGS. 2A-2C and 3.

In some examples, vehicle control system 100 can be connected (e.g., via controller 120) to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Vehicle control system 100 can control, via controller 120, one or more of these actuator systems 130 during vehicle operation; for example, to open or close one or more of the doors of the vehicle using the door actuator system 138, to control the vehicle during autonomous driving operations, using the motor 131 or engine 132, battery system 133, transmission gearing 134, suspension setup 135, brakes 136, and/or steering system 137, etc. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle), and one or more tactile actuators 144 in the vehicle (e.g., as part of a steering wheel or seat in the vehicle). Vehicle control system 100 can control, via controller 120, one or more of these indicator systems 140 to provide indications to a driver.

FIG. 2A illustrates an exemplary vehicle 200 automatically detecting a vehicle failure while driving along road 202 according to examples of the disclosure. Vehicle 200 can be equipped with a plurality of sensors for detecting one or more characteristics about the vehicle (e.g., detecting vehicle failures) (e.g., as described above with reference to FIG. 1). These sensors can include pressure, temperature, speed, air flow, smoke, steering, braking, battery, and/or any other sensors that can be used to detect vehicle failures and other characteristics about the vehicle. For example, vehicle 200 can detect a flat tire, sensor failure, powertrain trouble, a collision, locked steering, overheating of the battery, and/or any other vehicle failure. In some examples, vehicle 200 can be operating in an automated driving mode (e.g., driving autonomously without user input), in an assisted driving mode (e.g., allowing automated driving operations such as automatically changing lanes, slowing down, pulling over, or any other automated driving operation), or in a manual driving mode (e.g., a driver controlling all driving operations) when it detects the vehicle failure. Vehicle 200 can be equipped with one or more road hazard indicators such as hazard lights (including four-way hazard flashers, amber signaling lighting, strobes, and LEDs), flares (including electronic flares), light sticks, reflective triangles, cones, and/or any other road hazard indicators. In some examples, road hazard indicators (e.g., the reflective triangles or cones) can be coated or composed of radar reflective material so that the road hazard indicators can easily be detected by other vehicles equipped with radar sensors. In some examples, the road hazard indicators can be constructed so as to not harm other vehicles if the other vehicles were to run over them or hit them. In some examples, the one or more road hazard indicators can be stored under the vehicle, in the rear of the vehicle, in the trunk, on the top of the vehicle, and/or anywhere else on or in the vehicle that they can be automatically deployed. In some examples, vehicle 200 can automatically activate (e.g., illuminate) its hazard lights when the vehicle failure is detected. In some examples, vehicle 200 can also automatically slow down and/or pull off of the road, if possible (e.g., the vehicle does not completely break down and/or is safe to do so), after the vehicle failure is detected.

In some examples, vehicle 200 can immediately notify other vehicles that it is experiencing a vehicle failure. For example, vehicle 200 can immediately activate its hazard lights and/or any other visual and/or audio indicators (e.g., as described above with reference to FIG. 1) as the vehicle begins to slow down or when it stops. In some examples, vehicle 200 can broadcast a vehicle failure notification to other vehicles or systems (e.g., through vehicle-to-vehicle, Internet, cellular, radio, or any other wireless communication channels and/or technologies). For example, vehicle 200 can broadcast a sig-alert, can update a centralized or shared HD map, and/or provide any other form of notification to other vehicles or systems. In this way, other vehicles or drivers can know slow down and/or avoid vehicle 200 (e.g., change lanes or take an alternate route).

FIG. 2B illustrates exemplary vehicle 200 automatically deploying road hazard indicators 204 onto road 202 according to examples of the disclosure. Vehicle 200 can be equipped with Global Navigation Satellite System (GNSS) (e.g., GPS, BeiDou, Galileo, etc.) receivers, cellular positioning systems, map systems, and/or cloud services systems for detecting one or more characteristics about the vehicle (e.g., its location, orientation, and/or speed) and optical cameras, ultrasonic sensors, radar sensors, laser sensors, and/or LIDAR sensors for determining one or more characteristics about the vehicle's surroundings. These sensors can be configured on vehicle 200 to provide it with 360 degree (or other) coverage of the area surrounding the vehicle. In this way, vehicle 200 can use its systems and sensors to determine its location (including its speed and/or orientation) and one or more characteristics about the vehicle's surroundings (e.g., information about the road, other vehicles, objects or pedestrians, lighting conditions, weather conditions, and/or any other characteristics about the vehicle's surroundings) when the failure occurs. For example, vehicle 200 can process data from its sensors to determine whether any other vehicles, objects, and/or pedestrians are behind it. In this way, vehicle 200 can strategically and safely deploy road hazard indicators 204 behind vehicle 200 (e.g., drop them as the vehicle stops or pulls over or launch them if the vehicle is already stopped). For example, after detecting a flat tire, vehicle 200 can automatically slow down below a speed threshold (e.g., below 20, 15, or 10 miles per hour), determine that no vehicle is immediately behind it (e.g., not within 100 or 200 yards), and drop road hazard indicators 204 onto road 202 as the vehicle stops and/or pulls over. One of more of these steps can be performed by an autonomous driving (or ADAS) controller such as controller 120 of FIG. 1. In some examples, vehicle 200 can cache its system and sensor data in case the vehicle failure is sensor failure (e.g., sensor blindness). In some examples, vehicle 200 can receive information about one or more characteristics about the vehicle (e.g., location, orientation, and/or speed) and/or one or more characteristics about its surroundings from other vehicles on road 202 (e.g., through vehicle-to-vehicle, Internet, cellular, radio, or any other wireless communication channels and/or technologies). In this way, vehicle 200 can detect one or more characteristics about its surroundings and determine one or more characteristics about its surroundings even after sensor failure.

In some examples, vehicle 200 can deploy one or more road hazard indicators 204 on road 202 in compliance with traffic regulations and/or at predetermined distances. For example, each of road hazard indicators 204 can be deployed approximately 30 feet from each other, with the closest road hazard indicator to vehicle 200 being set approximately 10 feet from the vehicle. In some examples, road hazard indicators 204 can be connected to cord 206 at preset distances for easy placement. In some examples, cord 206 can be a rope, a chain, a cable, or any other linkage between the road hazard indicators. In some examples, cord 206 can be one continuous cord or can be segmented from road hazard indicator to road hazard indicator. In some examples, vehicle 200 can automatically retract cord 206 and/or road hazard indicators 204 once the vehicle failure has been addressed. In some examples, a user can invoke the deployment and/or retraction of the road hazard indicators through a control system such as a button, a touch screen, a voice command, a computer, a smartphone, or any device or system that allows user input to be entered. In this way, a user can safely deploy the road hazard indicators for any reason (e.g., in case of a medical emergency that requires the vehicle to pull over and stop).

In some examples, road hazard indicators 204 can have robotic capabilities (whether connected via a cord 206 or not). In some examples, each road hazard indicator 204 can be equipped with sensors to determine its own location, detect one or more characteristics about the vehicle (e.g., location, speed, and/or orientation), and/or determine one or more characteristics about the vehicle's surroundings (e.g., information about other vehicles, objects, pedestrians, and/or lane markings) and wheels to allow it to automatically roll to its desired location. For example, road hazard indicators 204 can be equipped with a GPS receivers, cameras, and/or radar, LIDAR, and/or ultrasonic sensors. In some examples, road hazard indicators 204 can calculate their location as an offset from the vehicle's location. In some examples, road hazard indicators 204 can be deployed (individually or simultaneously) and each can automatically detect vehicle 200, other vehicles, lane markings, and/or objects (including other road hazard indicators) to determine a desired destination relative to vehicle 200, to each other (e.g., in accordance with traffic regulations), and to any lane markings and automatically move to that desired destination. In this way, the road hazard indicators can easily arrange themselves in different configurations. For example, road hazard indicators 204 can be arranged so as to guide other vehicles to a different lane. In some examples, vehicle 200 (or a user) can control the movements (e.g., the placement) of the road hazard indicators 204 remotely. In some examples, the road hazard indicators 204 can broadcast a vehicle failure notification (e.g., through vehicle-to-vehicle, Internet, cellular, radio, or any other wireless communication channels and/or technologies) and serve as a beacon to other vehicles.

In some examples, vehicle 200 can deploy a ground-based robot to automatically place the one or more road hazard indicators 204 behind vehicle 200. In some examples, vehicle 200 can deploy a drone (or aerial robot) to automatically place road hazard indicators behind vehicle 200 (e.g., drop the road hazard indicators on the road and/or land on the road and deploy the hazard indicators). In some examples, the ground-based robot and/or drone can each be equipped with sensors to determine its location, detect one or more characteristics about the vehicle (e.g., location, speed, and/or orientation), and/or detect one or more characteristics about the vehicle's surroundings (e.g., information about other vehicles, objects, pedestrians, and/or lane markings). In this way, the ground-based robot and/or drone can each determine where to place the road hazard indicators while avoiding other vehicles, objects, and/or pedestrians. In some examples, the ground-based robot or the drone can automatically gather or retract the one or more road hazard indicators 204 and return to vehicle 200 once the vehicle failure has been addressed. In some examples, a user can manually invoke the ground-based robot and/or the drone to gather the one or more road hazard indicators 204 and return to vehicle 200 through a control system such as a button, a touch screen, a voice command, a computer, a smartphone, or any device or system that allows user input to be entered. In some examples, the ground-based robot and/or drone can communicate with vehicle 200, a driver, a user, a passenger, and/or any other third party. For example, the ground-based robot and/or drone can communicate sensor data to vehicle 200 (e.g., through Internet, cellular, radio, or any other wireless communication channels and/or technologies). In another example, the ground-based robot and/or drone can notify to a user that he or she may exit the vehicle (e.g., to push the vehicle off of the road, to address the vehicle failure, and/or for any other purpose). In some examples, the notification can be on any of the vehicle's display system(s) (e.g., the control, entertainment, infotainment, and/or heads up display system(s)), a smartphone, or any other electronic device with a display. In some examples, the ground-based robot and/or drone can be coated or composed of radar reflective material so that they can easily be detected by other vehicles equipped with radar sensors.

In some examples, vehicle 200 can request that one or more other vehicles on road 202 activate or deploy one or more road hazard indicators. For example, vehicle 200 can be traveling in a platoon (e.g., a group of vehicles autonomously driving in line and/or communicating with other vehicles to conserve resources) or in a caravan, and it can request that one or more other vehicles in the platoon or caravan deploy one or more hazard indicators. In another example, vehicle 200 could have been involved in a collision, causing it to be unable to deploy its hazard indicators (or may not have working hazard indicators for any reason), and it can request that one or more vehicles around it deploy one or more hazard indicators (e.g., drop flares or any other hazard indicators around vehicle 200 and/or any other vehicles involved in the collision). In some examples, vehicle 200 can broadcast (e.g., through vehicle-to-vehicle, Internet, cellular, radio, or any other wireless communication channels and/or technologies) a request for other vehicle's stop so that vehicle 200 can be moved off of the road (e.g., pushed or towed) and/or the vehicle failure can be addressed. In some examples, the other vehicles can accept, deny, or ignore these requests.

FIG. 2C illustrates exemplary vehicle 200 automatically projecting images of road hazard indicators 208 and 210 onto road 2002 according to examples of the disclosure. In some examples, vehicle 200 can monitor environmental conditions (e.g., weather conditions and/or lighting conditions) through the vehicle's sensors, or it can obtain such information from an external source (e.g., another vehicle and/or an internet source). In this way, vehicle 200 can select and deploy effective road hazard indicators (e.g., as described below with reference to FIG. 3). For example, vehicle 200 can be equipped with one or more projectors, lasers, or any other light source for projecting images onto road 202. In this way, vehicle 200 can project road hazard indicators 208 (e.g., arrows) and 210 (e.g., triangles) in dark lighting conditions (e.g., at night or in a tunnel). In some examples, vehicle 200 can project images of road hazard indicators in addition to or instead of the physical road hazard indicators discussed above with reference to FIGS. 2A-2B.

FIG. 3 illustrates an exemplary process 300 for automatically deploying road hazard indicators according to examples of the disclosure. In some examples, process 300 can be performed continuously or repeatedly by the vehicle during driving procedures. In some examples, process 300 can be performed while the vehicle is in any driving mode (e.g., in an automated driving mode, an assisted driving mode, or a manual driving mode)

At step 310, process 300 can detect a vehicle failure (e.g., as described above with reference to FIGS. 2A-2C). For example, process 300 can detect a flat tire, a collision, powertrain trouble, locked steering, sensor blindness (e.g., sensor failure), overheating, or any other vehicle failure that would make it unsafe for the vehicle to continue driving. In some examples, process 300 can notify a designated third party about the vehicle failure. The notification can be a phone call, text message, email, or any form of electronic or audible/visual communication to an electronic device associated with the third party (e.g., smartphone or other electronic device) or to another human being. The designated third party can be the vehicle's owner, the driver, a passenger, a call center, a towing company, a 911 operator, and/or any other third party. In some examples, process 300 can broadcast a vehicle failure notification to other vehicles or systems (e.g., through vehicle-to-vehicle, Internet, cellular, radio, or any other wireless communication channels and/or technologies) at step 310 (e.g., as described above with reference to FIG. 2A).

At step 320, process 300 can automatically select one or more road hazard indicators to deploy (e.g., drop, launch, illuminate, and/or project). In some examples, process 300 can process data from the vehicle's sensors to monitor one or more characteristics about the vehicle's surroundings when making this selection (e.g., as described above with reference to FIGS. 2A-2C). For example, process 300 can consider weather, lighting, road, traffic, and/or any other safety or environmental conditions at step 320. For example, in dark lighting conditions (e.g., at night or in a tunnel), process 300 can select one or more road hazard indicators that are visible in dark lighting conditions (e.g., flares, hazard lights, strobes, LEDs, light sticks, reflective triangles, and/or projected images) at step 320. In bright lighting conditions (e.g., during the day or a well-lit area), process 300 can select one or more road hazard indicators that are visible in bright lighting conditions (e.g., flares, hazard lights, and/or cones) at step 320. In some examples, process 300 can select hazard lights and/or projected images by default or in heavy traffic conditions (e.g., if one or more vehicles are immediately behind the vehicle) to avoid damaging the road hazard indicator and/or any other vehicle. In some examples, process 300 can select hazard lights when the vehicle is traveling equal to or above a threshold speed (e.g., equal to or above 20, 15, or 10 miles per hour). In some examples, process 300 can avoid selecting flares (or other flammable road hazard indicators) if process 300 detects flammable liquid(s) around the vehicle. In some examples, process 300 can avoid selecting reflective triangles if process 300 detects strong winds (e.g., wind gusts over 30 miles per hour). In some examples, a user may be able to set preferences for how to deploy road hazard indicators (e.g., set an order of preference). In some examples, a user may set road hazard indicator preferences through a control system such as a button, a touch screen, a voice command, a computer, a smartphone, or any device or system that allows user input to be entered.

At step 330, process 300 can deploy the one or more selected road hazard indicators from step 320 (e.g., as described above with reference to FIGS. 2A-2C). In some examples, process 300 can determine whether to drop, launch, illuminate, and/or project the one or more selected road hazard indicators at step 330 (e.g., as described above with reference to FIGS. 2A-2C). For example, process 300 will drop the one or more selected road hazard indicators if the vehicle is slowing down (and is moving below a threshold speed such as 20, 15, or 10 miles per hour) to stop or pull over and process 300 does not detect any other vehicles immediately behind the vehicle (e.g., as described above with reference to FIGS. 2B-2C). In some examples, process 300 will launch the one or more selected road hazard if the vehicle is stopped and process 300 does not detect any other vehicles or pedestrians near the vehicle. In some examples, the one or more selected road hazard indicators can be coupled to one or more parachutes. In this way, process 300 can launch the one or more selected road hazard indicators by releasing the one or more parachutes while the vehicle is moving so that the airflow surrounding the moving vehicle pulls/lifts the one or more vehicle hazard indicators from the vehicle and slowly drops them behind the vehicle. In some examples, process 300 will activate (e.g., illuminate) its hazard lights by default and/or if process 300 detects other vehicles or pedestrians near the vehicle. In some examples, process 300 can also retract the one or more vehicle hazard indicators. In some examples, process 300 can deploy a ground-based robot or a drone to arrange the one or more road hazard indicators on the road (e.g., as described above with reference to FIGS. 2B-2C). In some examples, process 300 can cause the ground-based robot or the drone to gather and return the one or more road hazard indicators to the vehicle once the failure is addressed or if invoked by the user (e.g., as described above with reference to FIGS. 2B-2C). In some examples, the road hazard indicators, ground-based robot, and/or drone can be coated or composed of radar reflective material so that they can easily be detected by other vehicles equipped with radar sensors.

Thus, the examples of the disclosure provide various ways to automatically deploy road hazard indicators.

Therefore, according to the above, some examples of the disclosure are directed to a system comprising: a first set of one or more sensors; a second set of one or more sensors; one or more processors coupled to the first set of one or more sensors and the second set of one or more sensors; and a memory including instructions, which when executed by the one or more processors, cause the one or more processors to perform a method comprising: detecting one or more characteristics about a vehicle via the first set of one or more sensors; determining one or more characteristics about the vehicle's surroundings via the second set of one or more sensors; detecting a vehicle failure via the first set of one or more sensors; in response to detecting the vehicle failure via the first one or more sensors, selecting one or more road hazard indicators using the one or more characteristics about the vehicle's surroundings; and after selecting the one or more road hazard indicators using the one or more characteristics about the vehicle's surroundings, deploying the one or more road hazard indicators. Additionally or alternatively to one or more of the examples disclosed above, in some examples, selecting the one or more road hazard indicators using the one or more characteristics about the vehicle's surroundings comprises: determining lighting conditions around the vehicle via the second set of one or more sensors; and in response to determining the lighting conditions around the vehicle: in accordance with a determination that the lighting conditions around the vehicle are bright lighting conditions, selecting a first set of one or more road hazard indicators that are visible in said bright lighting conditions; and in accordance with a determination that the lighting conditions are dark lighting conditions, selecting a second set of one or more road hazard indicators that are visible in said dark lighting conditions. Additionally or alternatively to one or more of the examples disclosed above, in some examples, selecting the first set of one or more road hazard indicators that are visible in said bright lighting conditions comprises selecting one or more of flares, hazard lights, and cones. Additionally or alternatively to one or more of the examples disclosed above, in some examples, selecting the second set of one or more road hazard indicators that are visible in said dark lighting conditions comprises selecting one or more of projected images and reflective triangles. Additionally or alternatively to one or more of the examples disclosed above, in some examples, selecting the one or more road hazard indicators using the one or more characteristics about the vehicle's surroundings comprises foregoing selecting flares when flammable liquids are detected via the second set of one or more sensors. Additionally or alternatively to one or more of the examples disclosed above, in some examples, deploying the one or more road hazard indicators comprises deploying the one or more road hazard indicators based on the one or more characteristics about a vehicle and the one or more characteristics about the vehicle's surroundings. Additionally or alternatively to one or more of the examples disclosed above, in some examples, deploying the one or more road hazard indicators comprises launching the one or more road hazard indicators when the vehicle is stopped and no other vehicles are behind the vehicle. Additionally or alternatively to one or more of the examples disclosed above, in some examples, deploying the one or more road hazard indicators comprises dropping the one or more road hazard indicators when a speed of the vehicle is below a threshold and no other vehicles are behind the vehicle. Additionally or alternatively to one or more of the examples disclosed above, in some examples, deploying the one or more road hazard indicators comprises activating one or more hazard lights when a speed of the vehicle is equal to or above the threshold or one or more other vehicles are behind the vehicle. Additionally or alternatively to one or more of the examples disclosed above, in some examples, the first set of one or more sensors comprise one or more of a GPS receiver, a pressure sensor, a temperature sensor, a speed sensor, an air flow sensor, and a smoke sensor. Additionally or alternatively to one or more of the examples disclosed above, in some examples, the second set of one or more sensors comprise one or more of an optical camera, an ultrasonic sensor, a radar sensor, a laser sensor, and a LIDAR sensor. Additionally or alternatively to one or more of the examples disclosed above, in some examples, the one or more characteristics about the vehicle comprising the vehicle's location, orientation, and speed. Additionally or alternatively to one or more of the examples disclosed above, in some examples, the vehicle failure comprises one of a flat tire, sensor failure, powertrain trouble, a collision, locked steering, and overheating. Additionally or alternatively to one or more of the examples disclosed above, in some examples, the one or more road hazard indicators comprise one or more of a hazard light, a flare, a light stick, a reflective triangle, and a cone. Additionally or alternatively to one or more of the examples disclosed above, in some examples, the hazard lights comprise four-way hazard flashers, amber signaling lighting, strobes, and LEDs. Additionally or alternatively to one or more of the examples disclosed above, in some examples, the second set of one or more sensors is located on one or more other vehicles. Additionally or alternatively to one or more of the examples disclosed above, in some examples, deploying the one or more road hazard indicators comprises notifying one or more other vehicles about the vehicle failure.

Some examples of the disclosure are directed to a non-transitory computer-readable medium including instructions, which when executed by one or more processors, cause the one or more processors to perform a method comprising: detecting one or more characteristics about a vehicle via a first set of one or more sensors; determining one or more characteristics about the vehicle's surroundings via a second set of one or more sensors; detecting a vehicle failure via the first set of one or more sensors; in response to detecting the vehicle failure via the first one or more sensors, selecting one or more road hazard indicators using the one or more characteristics about the vehicle's surroundings; and after selecting the one or more road hazard indicators using the one or more characteristics about the vehicle's surroundings, deploying the one or more road hazard indicators.

Some examples of the disclosure are directed to a vehicle comprising: a first set of one or more sensors; a second set of one or more sensors; one or more processors coupled to the first set of one or more sensors and the second set of one or more sensors; and a memory including instructions, which when executed by the one or more processors, cause the one or more processors to perform a method comprising: detecting one or more characteristics about the vehicle via the first set of one or more sensors; determining one or more characteristics about the vehicle's surroundings via the second set of one or more sensors; detecting a vehicle failure via the first set of one or more sensors; in response to detecting the vehicle failure via the first one or more sensors, selecting one or more road hazard indicators using the one or more characteristics about the vehicle's surroundings; and after selecting the one or more road hazard indicators using the one or more characteristics about the vehicle's surroundings, deploying the one or more road hazard indicators.

Some examples of the disclosure are directed to a method comprising: detecting one or more characteristics about a vehicle via a first set of one or more sensors; determining one or more characteristics about the vehicle's surroundings via a second set of one or more sensors; detecting a vehicle failure via the first set of one or more sensors; in response to detecting the vehicle failure via the first one or more sensors, selecting one or more road hazard indicators using the one or more characteristics about the vehicle's surroundings; and after selecting the one or more road hazard indicators using the one or more characteristics about the vehicle's surroundings, deploying the one or more road hazard indicators.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
a first set of one or more sensors;
a second set of one or more sensors;
one or more processors coupled to the first set of one or more sensors and the second set of one or more sensors; and
a memory including instructions, which when executed by the one or more processors, cause the one or more processors to perform a method comprising:
detecting one or more characteristics about a vehicle via the first set of one or more sensors;
determining one or more characteristics about the vehicle's surroundings via the second set of one or more sensors;
detecting a vehicle failure via the first set of one or more sensors;
in response to detecting the vehicle failure via the first one or more sensors, selecting one or more road hazard indicators using the one or more characteristics about the vehicle's surroundings; and
after selecting the one or more road hazard indicators using the one or more characteristics about the vehicle's surroundings, deploying the one or more road hazard indicators.

2. The system of claim 1, wherein:
selecting the one or more road hazard indicators using the one or more characteristics about the vehicle's surroundings comprises:
determining lighting conditions around the vehicle via the second set of one or more sensors; and
in response to determining the lighting conditions around the vehicle:
in accordance with a determination that the lighting conditions around the vehicle are bright lighting conditions, selecting a first set of one or more road hazard indicators that are visible in said bright lighting conditions; and
in accordance with a determination that the lighting conditions are dark lighting conditions, selecting a second set of one or more road hazard indicators that are visible in said dark lighting conditions.

3. The system of claim 2, wherein selecting the first set of one or more road hazard indicators that are visible in said bright lighting conditions comprises selecting one or more of flares, hazard lights, and cones.

4. The system of claim 2, wherein selecting the second set of one or more road hazard indicators that are visible in said dark lighting conditions comprises selecting one or more of projected images and reflective triangles.

5. The system of claim 1, wherein selecting the one or more road hazard indicators using the one or more characteristics about the vehicle's surroundings comprises foregoing selecting flares when flammable liquids are detected via the second set of one or more sensors.

6. The system of claim 1, wherein deploying the one or more road hazard indicators comprises deploying the one or more road hazard indicators based on the one or more characteristics about a vehicle and the one or more characteristics about the vehicle's surroundings.

7. The system of claim 6, wherein deploying the one or more road hazard indicators comprises launching the one or more road hazard indicators when the vehicle is stopped and no other vehicles are behind the vehicle.

8. The system of claim 7, wherein deploying the one or more road hazard indicators comprises dropping the one or more road hazard indicators when a speed of the vehicle is below a threshold and no other vehicles are behind the vehicle.

9. The system of claim 8, wherein deploying the one or more road hazard indicators comprises activating one or more hazard lights when a speed of the vehicle is equal to or above the threshold or one or more other vehicles are behind the vehicle.

10. The system of claim 1, wherein the first set of one or more sensors comprise one or more of a GPS receiver, a pressure sensor, a temperature sensor, a speed sensor, an air flow sensor, and a smoke sensor.

11. The system of claim 1, wherein the second set of one or more sensors comprise one or more of an optical camera, an ultrasonic sensor, a radar sensor, a laser sensor, and a LIDAR sensor.

12. The system of claim 1, wherein the one or more characteristics about the vehicle comprising the vehicle's location, orientation, and speed.

13. The system of claim 1, wherein the vehicle failure comprises one of a flat tire, sensor failure, powertrain trouble, a collision, locked steering, and overheating.

14. The system of claim 1, wherein the one or more road hazard indicators comprise one or more of a hazard light, a flare, a light stick, a reflective triangle, and a cone.

15. The system of claim 5 wherein the hazard lights comprise four-way hazard flashers, amber signaling lighting, strobes, and LEDs.

16. The system of claim 1, wherein the second set of one or more sensors is located on one or more other vehicles.

17. The system of claim 1, wherein deploying the one or more road hazard indicators comprises notifying one or more other vehicles about the vehicle failure.

18. A non-transitory computer-readable medium including instructions, which when executed by one or more processors, cause the one or more processors to perform a method comprising:
detecting one or more characteristics about a vehicle via a first set of one or more sensors;
determining one or more characteristics about the vehicle's surroundings via a second set of one or more sensors;
detecting a vehicle failure via the first set of one or more sensors;
in response to detecting the vehicle failure via the first one or more sensors, selecting one or more road hazard indicators using the one or more characteristics about the vehicle's surroundings; and
after selecting the one or more road hazard indicators using the one or more characteristics about the vehicle's surroundings, deploying the one or more road hazard indicators.

19. A vehicle comprising:
a first set of one or more sensors;
a second set of one or more sensors;
one or more processors coupled to the first set of one or more sensors and the second set of one or more sensors; and
a memory including instructions, which when executed by the one or more processors, cause the one or more processors to perform a method comprising:
detecting one or more characteristics about the vehicle via the first set of one or more sensors;
determining one or more characteristics about the vehicle's surroundings via the second set of one or more sensors;
detecting a vehicle failure via the first set of one or more sensors;
in response to detecting the vehicle failure via the first one or more sensors, selecting one or more road hazard indicators using the one or more characteristics about the vehicle's surroundings; and
after selecting the one or more road hazard indicators using the one or more characteristics about the vehicle's surroundings, deploying the one or more road hazard indicators.
